(19) United States
(12) Patent Application Publication
(10) Pub. No.: US 2005/0169399 A1
(43) Pub. Date: Aug. 4, 2005

(54) Signal field scaler, method of scaling a signal field and communications system employing the same

(75) Inventors: David P. Magee, Plano, TX (US); Michael T. DiRenzo, Coppell, TX (US); Manish Goel, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/029,289

(22) Filed: Jan. 5, 2005

Related U.S. Application Data
(60) Provisional application No. 60/542,242, filed on Feb. 4, 2004.

(51) Int. Cl. H04L 1/02

(52) U.S. Cl. 375/267

(57) ABSTRACT

The present invention provides a signal field scaler for use with a multiple-input, multiple-output (MIMO) transmitter employing N transmit antennas, where N is at least two. In one embodiment, the signal field scaler includes a signal field generator configured to provide a signal field corresponding to a multiple concurrent transmission to each of the N transmit antennas during a time interval. Additionally, the signal field scaler also includes a signal field adapter coupled to the signal field generator and configured to apply a vector of scale factors to the signal field for each of the N transmit antennas during the time interval to allow proper decoding of the signal field by a legacy receiver and a MIMO receiver.

### CROSS-REFERENCE TO PROVISIONAL APPLICATION

This application claims the benefit of U.S. Provisional Application No. 60/542242 entitled “Signal Field Scaling in Wireless MIMO Preambles To Ensure Backward Compatible Decoding In 802.11a Systems” to David P. Magee, et al., filed on Feb. 4, 2004, which is incorporated herein by reference in its entirety.

### TECHNICAL FIELD OF THE INVENTION

The present invention is directed, in general, to communication systems and, more specifically, to a signal field scaler, a method of scaling a signal field and a multiple-input, multiple-output (MIMO) communications system employing the scaler or the method.

### BACKGROUND OF THE INVENTION

Multiple-input, multiple-output (MIMO) communication systems differ from single-input, single-output (SISO) communication systems in that different data symbols are transmitted simultaneously using multiple antennas. MIMO systems typically employ a cooperating collection of single-dimension transmitters to send a vector symbol of information, which may represent one or more coded or uncoded SISO data symbols. A cooperating collection of single-dimension receivers, constituting a MIMO receiver, then receives one or more copies of this transmitted vector of symbol information. The performance of the entire communication system hinges on the ability of the MIMO receiver to establish reliable estimates of the symbol vector that was transmitted. This includes establishing several parameters, which include receiver automatic gain control and channel estimates for the receive signal.

As a result, training sequences contained in MIMO preambles that precede data transmissions are employed to train MIMO receivers to an appropriate level for each receive signal data path. For example, a 2×2 MIMO communication system employing orthogonal frequency division multiplexing (OFDM) may transmit two independent and concurrent signals, employing two single-dimension transmitters having separate transmit antennas and two single-dimension receivers having separate receive antennas. Two receive signals Y₁(k), Y₂(k) on the k^{th} sub-carrier or tone following a Fast Fourier Transformation and assuming negligible inter-symbol interference may be written as:
Y₁(k)=H₁₁(k)*X₁(k)+H₁₂(k)*X₂(k)+N₁(k) (1a)
Y₂(k)=H₂₁(k)*X₁(k)+H₂₂(k)*X₂(k)+N₂(k) (1b)
where X₁(k) and X₂(k) are two independent signals transmitted on the k^{th} sub-carrier/tone from the first and second transmit antennas, respectively, and N₁(k) and N₂(k) are noises associated with the two receive signals.

The channel coefficients Hᵢⱼ(k), where i=1,2 and j=1,2, incorporate gain and phase distortion associated with symbols transmitted on the k^{th} sub-carrier/tone from transmit antenna j to receive antenna i. The channel coefficients Hᵢⱼ(k) may also include gain and phase distortions due to signal conditioning stages such as filters and other analog electronics. The receiver is required to provide estimates of the channel coefficients Hᵢⱼ(k) to reliably decode the transmitted signals X₁(k) and X₂(k).

The MIMO preambles also contain signal fields that provide intended MIMO receivers with specific information regarding a forthcoming concurrent transmission. A legacy receiver associated with a SISO communication system also employs gain and channel estimation training as well as signal fields in a SISO preamble. Usually, the MIMO and SISO preamble structures are similar but significantly different such that the legacy receiver cannot properly decode the MIMO preamble information. The inability to properly decode the MIMO signal field causes the legacy receiver to typically begin to broadcast during the MIMO transmission thereby providing interference and additional noise to the MIMO environment.

Accordingly, what is needed in the art is a MIMO communication system that provides proper training for multiple concurrent data transmissions and allows proper signal field decoding for legacy communication systems.

### SUMMARY OF THE INVENTION

To address the above-discussed deficiencies of the prior art, the present invention provides a signal field scaler for use with a multiple-input, multiple-output (MIMO) transmitter employing N transmit antennas, where N is at least two. In one embodiment, the signal field scaler includes a signal field generator configured to provide a signal field corresponding to a multiple concurrent transmission to each of the N transmit antennas during a time interval. Additionally, the signal field scaler also includes a signal field adapter coupled to the signal field generator and configured to apply a vector of scale factors to the signal field for each of the N transmit antennas during the time interval to allow proper decoding of the signal field by a legacy receiver and a MIMO receiver.

In another aspect, the present invention provides a method of scaling a signal field for use with a multiple-input, multiple-output (MIMO) transmitter employing N transmit antennas, where N is at least two. The method includes providing a signal field corresponding to a multiple concurrent transmission to each of the N transmit antennas during a time interval. The method also includes applying a vector of scale factors to the signal field for each of the N transmit antennas during the time interval to allow proper decoding of the signal field by a legacy receiver and a MIMO receiver.

The present invention also provides, in yet another aspect, a communications system. The communications system employs a multiple-input, multiple-output (MIMO) transmitter having N transmit antennas, where N is at least two, that provides a multiple concurrent transmission and includes a signal field scaler. The signal field scaler has a signal field generator that provides a signal field corresponding to the multiple concurrent transmission to each of the N transmit antennas during a time interval. The signal field scaler also has a signal field adapter, coupled to the signal field generator, that applies a vector of scale factors to the signal field for each of the N transmit antennas during the time interval to allow proper decoding of the signal field. The communications system also employs a MIMO receiver, having M receive antennas, where M is at least two, that properly decodes the signal field and receives the multiple concurrent transmission, and a legacy receiver, employing a receive antenna, that properly decodes the signal field.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of a communication system constructed in accordance with the principles of the present invention;

FIG. 2 illustrates a diagram of an embodiment of a transmission frame format employable with a signal field scaler and constructed in accordance with the principles of the present invention; and

FIG. 3 illustrates a flow diagram of an embodiment of a method of scaling a signal field carried out in accordance with the principles of the present invention.

### DETAILED DESCRIPTION

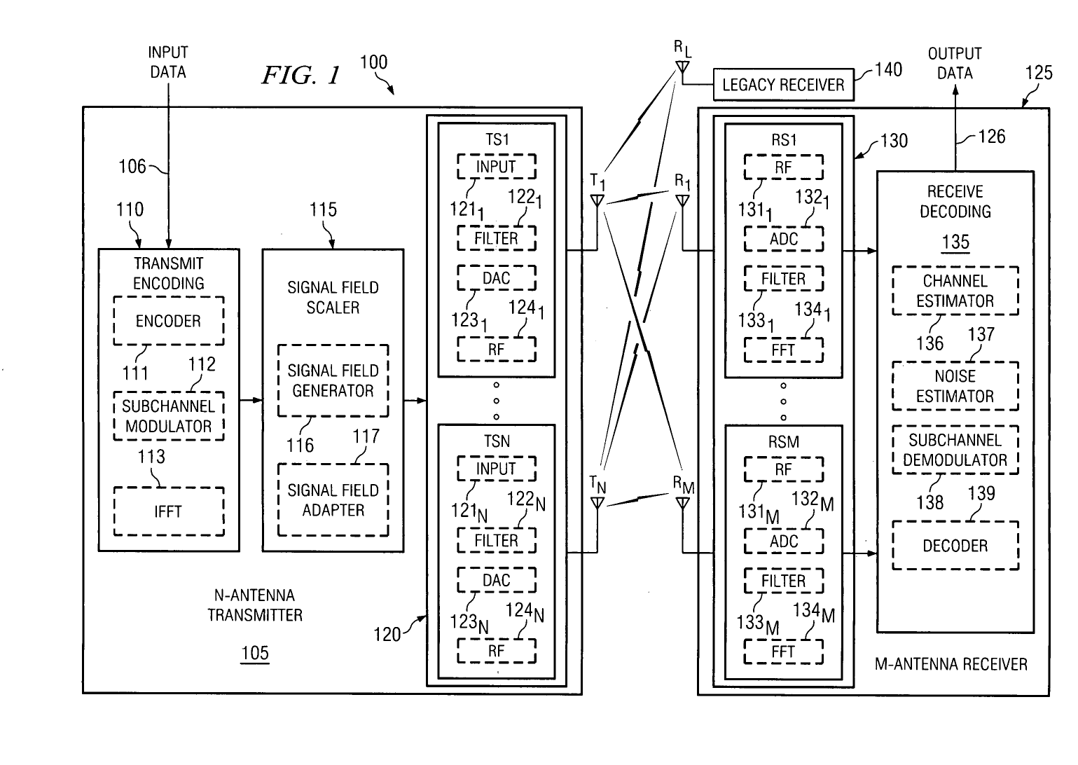

Referring initially to FIG. 1, illustrated is a system diagram of an embodiment of a communication system, generally designated 100, constructed in accordance with the principles of the present invention. The communication system 100 includes a MIMO transmitter 105, a MIMO receiver 125 and a legacy receiver 140. The MIMO transmitter 105 includes input data 106, a transmit encoding system 110, a signal field scaler 115, and a transmit system 120 having N transmit sections TS1-TSN coupled to N transmit antennas T1-TN, respectively. The MIMO receiver 125 includes a receive system 130 having M receive sections RS1-RSM respectively coupled to M receive antennas R1-RM, and a receive decoding system 135 providing output data 126. The legacy receiver 140 employs a receive antenna R_{L} coupled to a receive section and a receive decoding system (not shown) that process legacy transmissions.

In the embodiment of FIG. 1, N and M are at least two. The MIMO transmitter 105 provides multiple concurrent transmissions that include MIMO data and additional MIMO preambles. The MIMO receiver 125 employs gain training, channel estimation and signal field interpretation for receiving the multiple concurrent transmissions. The transmit encoding system 110 includes an encoder 111, a subchannel modulator 112 and an Inverse Fast Fourier Transform (IFFT) section 113. The encoder 111, subchannel modulator 112 and IFFT section 113 prepare the input data and support the arrangement of preamble information and signal information for transmission by the transmit system 120.

The signal field scaler 115 includes a signal field generator 116 and a signal field adapter 117, which cooperate with the transmit encoding system 110 to generate a scaled signal field. This allows proper decoding of the signal field transmissions by the legacy receiver 140 to allow it to remain silent during the multiple concurrent transmissions. Additionally, the signal field generator and adapter 116, 117 may be employed in either the frequency or time domain. For the time domain, an IFFT of the appropriate signal information may be pre-computed and read from memory at the required transmission time.

The N transmit sections TS1-TSN include corresponding pluralities of N input sections 121₁-121_{N}, N filters 122₁-122_{N}, N digital-to-analog converters (DACs) 123₁-123_{N} and N radio frequency (RF) sections 124₁-124_{N}, respectively. The N transmit sections TS1-TSN provide time domain signals proportional to preamble information, signal information and input data for transmission by the N transmit antennas T1-TN, respectively.

The M receive antennas R1-RM receive the transmission and provide it to the M respective receive sections RS1-RSM, which include corresponding M RF sections 131₁-131_{M}, M analog-to-digital converters (ADCs) 132₁-132_{M}, M filters 133₁-133_{M}, and M Fast Fourier Transform (FFT) sections 134₁-134_{M}, respectively. The M receive sections RS1-RSM employ a proper AGC level to provide frequency domain signals with similar time domain power levels to the receive decoding system 135. The receive decoding system 135 includes a channel estimator 136, a noise estimator 137, a subchannel demodulator 138 and a decoder 139 that employ preamble and gain training information, signal information and input data to provide the output data 126.

In the signal field scaler 115, the signal field generator 116 is configured to provide a signal field corresponding to the multiple concurrent transmission to each of the N transmit antennas during a time interval. Additionally, the signal field adapter 117 is coupled to the signal field generator 116 and configured to apply a vector of scale factors to the signal field for each of the N transmit antennas during the time interval to allow proper decoding of the signal field by the legacy receiver 140 while still accommodating the MIMO receiver 125. In the illustrated embodiment, the legacy receiver 140 conforms to the IEEE 802.11a standard as exemplary of the IEEE 802.11 standards. Proper decoding of the signal field associated with the MIMO transmission allows the legacy receiver 140 to remain in a dormant mode until the MIMO transmission is complete thereby insuring that it will not interfere with operation of the MIMO portions of the communications system 100.

In the illustrated embodiment, each vector of scale factors that is employed by the signal field scalar 115 for a particular transmit path in the MIMO transmission corresponds to the same vector of scale factors employed by channel estimation training sequences. These channel estimation training sequences are long sequences that provide backward compatibility with the IEEE 802.11a standard. For backward compatibility, the MIMO channel estimation training sequences contain a single symbol for each transmit path that is repeated to form a two-symbol training sequence equal to a scaled multiple of the IEEE 802.11a long sequences when summed on a tone by tone basis. As a result, a suite of MIMO channel estimation training sequences LSⱼ[k] that are employed with the N transmit antennas having K tones in an OFDM symbol may be written as:
LSⱼ[k]=LS[K]*Mⱼ[k] for 1≦j≦N and 1≦k≦K, (2)
where LS[k] is an unscaled channel estimation training sequence and Mⱼ[k] is a vector of K scale factors corresponding to the N transmit antennas. Since scaling often involves amplitude and phase, the scale factors Mⱼ[k] may be complex quantities. Then, for proper decoding at the legacy receiver 140, a suite of MIMO signal fields SIGⱼ[k] may be written as:
SIGⱼ[k]=SIG[k]*Mⱼ[k] for 1≦j≦N and 1≦k≦K, (3)
where SIG[k] is an unscaled signal field and Mⱼ[k] is the vector of K scale factors corresponding to the N transmit antennas employed with the channel estimation training sequences.

The scalable property of the signal field scaler allows it to accommodate the MIMO transmitter 105 when employing any N of at least two transmit antennas. This property accommodates the associated MIMO receiver 125 when employing any M of at least two receive antennas, to effectively receive additional MIMO preambles and MIMO data portions of a reception that are concurrently transmitted.

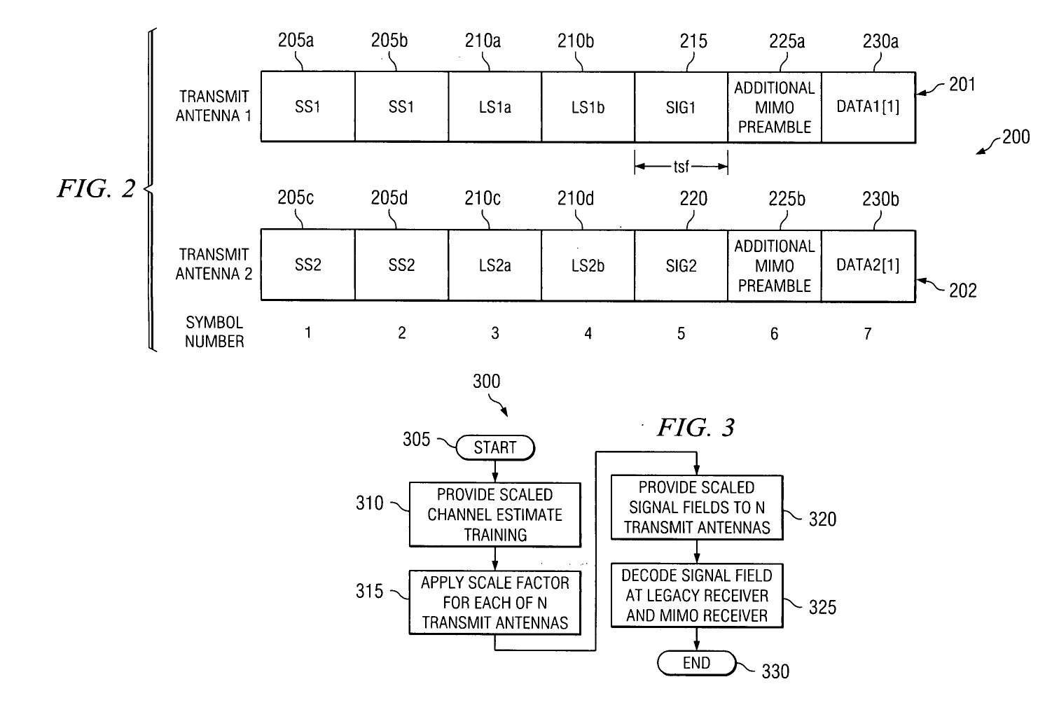

Turning now to FIG. 2, illustrated is a diagram of an embodiment of a transmission frame format, generally designated 200, employable with a signal field scaler and constructed in accordance with the principles of the present invention. The transmission frame format 200 includes first and second transmission frames 201, 202 that are associated with first and second transmit antennas of a MIMO transmitter as was discussed with respect to FIG. 1.

The first and second transmission frames 201, 202 include first and second sets of gain training sequences 205a, 205b and 205c, 205d, first and second sets of channel estimation training sequences 210a, 210b and 210c, 210d, first and second signal fields 215, 220, first and second additional MIMO preambles 225a, 225b and first and second data fields 230a, 230b. The first and second signal fields 215, 220 occur during a time interval t_{sf}, which follows time intervals associated with the first and second sets of channel estimation training sequences 210a, 210b and 210c, 210d.

In the illustrated embodiment, the first and second sets of gain training sequences 205a, 205b and 205c, 205d are short sequences and scaled representations of short sequences, respectively, that are compatible with the IEEE 802.11a standard. Additionally, the first and second sets of channel estimation training sequences 210a, 210b and 210c, 210d are long sequences and scaled representations of long sequences, respectively, that are also compatible with the IEEE 802.11a standard.

In the frequency domain, channel estimation determines any magnitude and phase differences between a known transmitted signal and a corresponding receive signal on a tone by tone basis. As a result, channel estimation training sequences may be designed to create an artificial magnitude and phase difference from an original channel estimation training sequence so that a legacy receive will just associate it with the channel. However, backward compatibility requires the same tone by tone scaling for a first channel estimation training sequence be applied to the second channel estimation training sequence for each transmit path. This is due to averaging algorithms that might exist in the receiver.

For the first transmit antenna, the first set of channel estimation training sequences 210a, 210b may be expressed as LS1a and LS1b and take the form of LS[k]*M₁[k] where a first scale factor M₁[k] is understood to be a sequence of all ones in equations (4a), (4b) below. Then:
LS1a=[0 0 0 0 0 0 1 1 −1 −1 1 1 −1 −1 1 1 1 1 1 −1 −1 1 1 −1 1 −1 1 1 1 0 1 −1 −1 1 −1 1 −1 1 −1 −1 −1 −1 −1 1 −1 −1 1 −1 1 −1 1 1 1 1 0 0 0 0 0]; (4a)
LS1b=[0 0 0 0 0 0 1 1 −1 −1 1 1 −1 1 −1 1 1 1 1 1 −1 −1 1 1 −1 1 −1 1 1 1 1 0 1 −1 −1 1 1 −1 1 −1 1 −1 −1 −1 −1 −1 1 1 −1 −1 1 −1 1 −1 1 1 1 1 0 0 0 0 0]; (4b)
These are standard long sequences for the IEEE 802.11a standard. For the second transmit antenna, the second set of channel estimation training sequences 210c, 210d may be expressed as LS2a and LS2b and also take the form of LS[k]*M₂[k], where a second scale factor M₂[k] differs from the first scale factor M₁[k] of all ones as may be seen in equations (5a), (5b) below.
LS2a=[0 0 0 0 0 0 1 1 −1 −1 1 1 −1 1 −1 1 1 1 1 1 1 −1 −1 1 1 −1 1 −1 1 1 1 1 0 1 −1 −1 1 1 −1 1 −1 1 −−1 −1 −1 −1 1 1 −1 −1 −1 1 −1 1 1 1 1 0 0 0 0 0].*[0 0 0 0 0 0 1 −1 1 −1 1 −1 1 −1 1 −1 1 −1 1 −1 1 −1 1 −1 1 −1 1 −1 1 −1 1 −1 0 1 −1 1 −1 1 −1 1 −1 1 −1 1 −1 1 −1 1 −1 1 −1 1 −1 1 −1 1 −1 1 −1 0 0 0 0 0]; (5a)
LS2b=[0 0 0 0 0 0 1 1 −−1 1 −1 −1 1 1 1 1 1 −1 −1 1 −1 1 −1 1 1 1 1 0 1 −1 −1 1 1 −1 −1 1 −1 −1 −1 −1 −1 1 −1 −1 −1 1 −1 1 1 1 1 0 0 0 0 0].*[0 0 0 0 0 0 1 −1 1 −1 1 −1 1 −1 1 −1 1 −1 1 −1 1 −1 1 −1 1 −1 1 −1 1 −1 1 −1 0 1 −1 1 −1 1 −1 1 −1 1 −1 1 −1 1 −1 1 −1 1 −1 1 −1 1 −1 1 −1 1 −1 0 0 0 0 0]; (5b)
where the operator “.*” implies a term by term multiplication thereby giving individual products on each individual term. The second set of channel estimation training sequences 210c, 210d may be generally represented as LS1[k]*M₂[k]. The vector of K scale factors Mj[k] (i.e., M₁[k], M₂[k] in this example) may take a variety of forms, as long as the channel estimation algorithm for the legacy receiver is able to accommodate the resulting scaled representation and treat it as a channel estimate.

The first and second signal fields 215, 220 contain information that includes data rate, packet length, parity, reserved and signal tail bits. Therefore, exact values of the signal fields depend on a particular packet. However, an examplary first and second signal fields 215, 220 may be expressed as SIG1 and SIG2 and take the form of SIG[k]*Mj[k], where a first scale factor M₁[k] is again understood to be a sequence of all ones. As may be seen, the second scale factor M₂[k] used in this example is the same one used above in equations (5a),(5b). Then, for a data rate of 24 Mbps and a packet length of 1024 bytes the first and second signal fields 215, 220 may be represented in equations (6a), (6b) as:
SIG1=[0 0 0 0 0 0 −1 1 −1 '1 −1 1 1 1 1 −1 1 1 −1 −1 −1 1 1 −1 −1 1 −1 −1 1 −1 −1 1 0 1 −1 −1 −1 −1 1 1 1 −1 1 1 −1 1 −1 −1 1 1 −1 −1 1 −1 1 1 1 1 1 0 0 0 0 0]; (6a)
SIG2=[0 0 0 0 0 0 −1 1 −1 −1 −1 1 1 1 1 −1 1 1 −1 −1 −1 1 1 −1 −1 1 −1 −1 1 −1 −1 1 0 1 −1 −1 −1 −1 1 1 1 −1 1 1 −1 1 −1 −1 1 1 −1 −1 1 −1 1 1 1 1 1 0 0 0 0 0 ].*[0 0 0 0 0 0 1 −1 1 −1 1 −1 1 −1 1 −1 1 −1 1 −1 1 −1 1 −1 1 1 1 1 −1 1 −1 1 −1 0 1 −1 1 −1 1 −1 1 −1 1 −1 1 −1 1 −1 1 −1 1 −1 1 −1 1 −1 1 −1 1 −1 0 0 0 0 0]; (6b)
where the operator “.*” again implies the term by term multiplication, as before.

Turning now to FIG. 3, illustrated is a flow diagram of an embodiment of a method of scaling a signal field, generally designated 300, carried out in accordance with the principles of the present invention. The method 300 is employed with a MIMO transmitter having an N of at least two transmit antennas to scale a signal field and starts in a step 305. Scaled channel estimate training is provided to a legacy receiver that conforms to an IEEE 802.11 standard in a step 310 wherein scale factors are employed to scale channel estimate training sequences. Each of the scale factors correlates to a vector of K scale factors associated with the N transmit antennas. Additionally, at least a portion of the scale factors are complex quantities representing amplitudes and phases.

Then, the scale factors are applied to the signal field for each of the N transmit antennas during a time interval, in a step 315, to allow proper decoding of the signal field. In a step 320, scaled signal fields corresponding to a multiple concurrent transmission from the MIMO transmitter are provided to each of the N transmit antennas during the time interval. The multiple concurrent transmission includes MIMO data and may include an additional MIMO preamble.

Proper decoding of the signal field by the legacy receiver, in the step 325, causes it to remain dormant for the multiple concurrent transmission. Proper decoding of the signal field by a MIMO receiver, in the step 325, also allows it to accommodate any additional MIMO preamble and the MIMO data. The method 300 ends in a step 330.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps are not limitations of the present invention.

In summary, embodiments of the present invention employing a signal field scaler, a method of scaling a signal field and a communications system employing the scaler or method have been presented. Use of the scaler or method of scaling allows a legacy receiver to properly decode the signal field associated with a MIMO transmission. Unless the signal field is properly scaled, the legacy receiver will not decode it properly and will typically remain active to provide interference with the MIMO transmission. Conversely, proper decoding of the signal field allows the legacy receiver to remain quiet during the MIMO transmission.

Although the present invention has been described in detail, those skilled in the art should understand that they can make various changes, substitutions and alterations herein without departing from the spirit and scope of the invention in its broadest form.

1. A signal field scaler for use with a multiple-input, multiple-output (MIMO) transmitter employing N transmit antennas, where N is at least two, comprising:
a signal field generator configured to provide a signal field corresponding to a multiple concurrent transmission to each of said N transmit antennas during a time interval; and
a signal field adapter coupled to said signal field generator and configured to apply a vector of scale factors to said signal field for each of said N transmit antennas during said time interval to allow proper decoding of said signal field by a legacy receiver and a MIMO receiver.

2. The scaler as recited in claim 1 wherein said vector of scale factors is one of N vectors corresponding to said N transmit antennas wherein each of said N vectors has K scale factors corresponding to K OFDM symbol tones.

3. The scaler as recited in claim 1 wherein said vector of scale factors is a complex quantity representing amplitude and phase.

4. The scaler as recited in claim 1 wherein said vector of scale factors is employed in channel estimation training sequences.

5. The scaler as recited in claim 1 wherein said proper decoding of said signal field by said legacy receiver causes it to remain dormant for said multiple concurrent transmission.

6. The scaler as recited in claim 1 wherein said legacy receiver conforms to an IEEE 802.11 standard.

7. The scaler as recited in claim 1 wherein said multiple concurrent transmission is selected from the group consisting of:
an additional MIMO preamble, and
MIMO data.

8. A method of scaling a signal field for use with a multiple-input, multiple-output (MIMO) transmitter employing N transmit antennas, where N is at least two, comprising:
providing a signal field corresponding to a multiple concurrent transmission to each of said N transmit antennas during a time interval; and
applying a vector of scale factors to said signal field for each of said N transmit antennas during said time interval to allow proper decoding of said signal field by a legacy receiver and a MIMO receiver.

9. The method as recited in claim 8 wherein said vector of scale factors is one of N vectors corresponding to said N transmit antennas wherein each of said N vectors has K scale factors corresponding to K OFDM symbol tones.

10. The method as recited in claim 8 wherein said vector of scale factors is a complex quantity representing amplitude and phase.

11. The method as recited in claim 8 wherein said vector of scale factors is employed in channel estimation training sequences.

12. The method as recited in claim 8 wherein said proper decoding of said signal field by said legacy receiver causes it to remain dormant for said multiple concurrent transmission.

13. The method as recited in claim 8 wherein said legacy receiver conforms to an IEEE 802.11 standard.

14. The method as recited in claim 8 wherein said multiple concurrent transmission is selected from the group consisting of:
an additional MIMO preamble, and
MIMO data.

15. A communications system, comprising:
a multiple-input, multiple-output (MIMO) transmitter employing N transmit antennas, where N is at least two, that provides a multiple concurrent transmission;
a signal field scaler that is coupled to said MIMO transmitter, including:
a signal field generator that provides a signal field corresponding to said multiple concurrent transmission to each of said N transmit antennas during a time interval, and
a signal field adapter, coupled to said signal field generator, that applies a vector of scale factors to said signal field for each of said N transmit antennas during said time interval to allow proper decoding of said signal field;
a MIMO receiver employing M receive antennas, where M is at least two, that properly decodes said signal field and receives the multiple concurrent transmission; and
a legacy receiver employing a receive antenna that properly decodes said signal field.

16. The communications system as recited in claim 15 wherein said vector of scale factors is one of N vectors corresponding to said N transmit antennas wherein each of said N vectors has K scale factors corresponding to K OFDM symbol tones.

17. The communications system as recited in claim 15 wherein said vector scale factors is a complex quantity representing amplitude and phase.

18. The communications system as recited in claim 15 wherein said vector of scale factors is employed in channel estimation training sequences.

19. The communications system as recited in claim 15 wherein said proper decoding of said signal field by said legacy receiver causes it to remain dormant for said multiple concurrent transmission.

20. The communications system as recited in claim 15 wherein said legacy receiver conforms to an IEEE 802.11 standard.

21. The communications system as recited in claim 15 wherein said multiple concurrent transmission is selected from the group consisting of:
an additional MIMO preamble, and
MIMO data.
